(19) United States
(12) Patent Application Publication
(10) Pub. No.: US 2024/0091914 A1
(43) Pub. Date: Mar. 21, 2024

(54) ELECTRIC POWER TOOL, AND METHOD FOR CONTROLLING MOTOR IN ELECTRIC POWER TOOL

(71) Applicant: MAKITA CORPORATION, Anjo-shi (JP)

(72) Inventors: Shu ISAKA, Anjo-shi (JP); Itsuku KATO, Anjo-shi (JP)

(73) Assignee: MAKITA CORPORATION, Anjo-shi (JP)

(21) Appl. No.: 18/240,412

(22) Filed: Aug. 31, 2023

(30) Foreign Application Priority Data
Sep. 16, 2022 (JP) 2022-148350

(51) Int. Cl. B25B 21/02; H02P 27/08

(52) U.S. Cl. CPC B25B 21/02; H02P 27/08

(57) ABSTRACT

An electric power tool in one aspect of the present disclosure includes a motor, an output shaft, a drive circuit, a rotation controller, a calculator, and a deceleration controller. The output shaft is configured to attach a tool bit thereto, and be rotated by the motor. The rotation controller rotates the output shaft to thereby loosen a fastener from a fastened material. The calculator increases a determination value in accordance with a lapse of time from a first timing, and varies a rate of increase in the determination value in accordance with a speed parameter. The deceleration controller decelerates or stops the motor based on the determination value having reached a threshold value.

### CROSS-REFERENCE TO RELATED APPLICATIONS

The present application claims the benefit of Japanese Patent Application No. 2022-148350 filed on Sep. 16, 2022 with the Japan Patent Office, the entire disclosure of which is incorporated herein by reference.

### BACKGROUND

The present disclosure relates to techniques for controlling a motor in an electric power tool.

Japanese Patent No. 6095526 discloses a rotary impact tool with a function to automatically stop a motor rotating in a reverse direction. This rotary impact tool stops the motor when a specified amount of time elapses without detection of hammering after the motor starts to drive in the reverse direction. The reverse direction corresponds to a direction in which an object (for example, a nut) is loosened.

### SUMMARY

In this rotary impact tool, the motor may be stopped in a state where a fastener is not sufficiently loose from the fastened material. In this case, a burdensome task may occur which requires a user of the rotary impact tool to (i) unscrew the fastener himself/herself after the motor stops or (ii) activate the rotary impact tool again to loosen the fastener after the motor stops.

It is desirable that one aspect of the present disclosure can provide techniques for automatically stopping the motor in a state where the fastener is properly loosened.

In the present disclosure, it should be noted that the terms such as “first” and “second” are intended simply to distinguish elements from each other, and are not intended to limit the order or the number of the elements. The first element may be referred to as the second element, and similarly, the second element may be referred to as the first element. In addition, the first element may be included without the second element, and similarly, the second element may be included without the first element.

One aspect of the present disclosure provides an electric power tool that includes a motor, an output shaft, a drive circuit, a rotation controller, a calculator, and a deceleration controller.

The output shaft is configured to (i) attach a tool bit thereto, and (ii) receive a rotational force of the motor to thereby rotate in a first tool rotation direction or a second tool rotation direction together with the tool bit. The second tool rotation direction is opposite to the first tool rotation direction. The tool bit is configured to tighten a fastener to a fastened material based on the tool bit being rotated in the first tool rotation direction. The tool bit is configured to loosen the fastener from the fastened material based on the tool bit being rotated in the second tool rotation direction. The fastener may have a screw thread.

The drive circuit supplies an electric power to the motor to thereby rotate the motor.

The rotation controller rotates the motor via the drive circuit so that the output shaft rotates in the second tool rotation direction.

The calculator increases a determination value in accordance with a lapse of time from a first timing. The calculator varies a rate of increase in the determination value in accordance with a speed parameter. The speed parameter relates to a rotation speed of the motor. The first timing arrives after the rotation controller starts rotating the motor so that the output shaft rotates in the second tool rotation direction.

The deceleration controller decelerates or stops the motor via the drive circuit based on the determination value having reached a threshold value. Decelerating the motor corresponds to decreasing the rotation speed of the motor. Stopping the motor corresponds to stopping the rotation of the motor.

In the electric power tool as above, the rate of increase in the determination value varies in accordance with the speed parameter. This can vary a period of time, which it takes for the determination value to reach the threshold value, in accordance with the speed parameter. Accordingly, the electric power tool as such can stop the motor in a state where the fastener is properly loosened.

Another aspect of the present disclosure provides an electric power tool that includes a motor, a rotation direction setter, and a control circuit. The motor (i) rotates in a first direction to thereby tighten a fastener to a fastened material, or (ii) rotates in a second direction to thereby loosen the fastener from the fastened material. The rotation direction setter sets a rotation direction of the motor to the first direction or the second direction. The control circuit rotates the motor in the second direction based on the rotation direction of the motor being set to the second direction. The control circuit increases a specified determination value in accordance with a lapse of time from a first timing. The first timing arrives after the control circuit starts rotating the motor in the second direction. The control circuit decelerates or stops the motor based on the determination value having reached a threshold value. The control circuit varies a rate of increase in the determination value in accordance with a speed parameter of the motor.

The electric power tool as above can also stop the motor in a state where the fastener is properly loosened.

Increasing the determination value may include integrating a count variable at a specific timing. A value obtained by integrating the count variable may correspond to the determination value. In other words, the integrated value may be used as the determination value. Varying the rate of increase may include varying the count variable.

Another aspect of the present disclosure provides a method for controlling a motor in an electric power tool, the method including:
rotating a tool bit in a specified rotation direction by a motor, the tool bit (i) being attached to the electric power tool, and (ii) being configured to loosen a fastener from a member being screwed by being rotated in the specified rotation direction;
increasing a determination value in accordance with a lapse of time from a first tuning;
varying a rate of increase in the determination value in accordance with a speed parameter, the speed parameter being related to a rotation speed of the motor; and
decelerating or stop the motor based on the determination value having reached a threshold value.

The method as such can stop the motor in a state where the fastener is properly loosened.

### BRIEF DESCRIPTION OF THE DRAWINGS

Example embodiments of the present disclosure will be described hereinafter with reference to the accompanying drawings, in which:

FIG. 1 is a side sectional view of an electric power tool in an example embodiment;

FIG. 2 is an explanatory view showing one example of an operation panel;

FIG. 3 is an electric circuit diagram showing an electrical configuration of the electric power tool;

FIG. 4 is a block diagram showing a function of a control circuit;

FIG. 5 is a time chart showing a first operation example of the electric power tool when a motor rotates reversely;

FIG. 6 is time chart showing a second operation example of the electric power tool when the motor rotates reversely;

FIG. 7 is a flowchart of a reverse rotation control process; and

FIG. 8 is a flowchart of a determination requirement confirmation process.

### DETAILED DESCRIPTION OF EXEMPLARY EMBODIMENTS

### 1. Overview of Embodiments

One embodiment may provide an electric power tool including at least any one of:
Feature 1: a motor;
Feature 2: an output shaft (or an attachment portion) configured to (i) attach a tool bit thereto, and (ii) receive a rotational force of the motor to thereby rotate in a first tool rotation direction or a second tool rotation direction together with the tool bit;
Feature 3: the second tool rotation direction is opposite to the first tool rotation direction;
Feature 4: the tool bit is configured to tighten a fastener to a fastened material based on the tool bit being rotated in the first tool rotation direction:
Feature 5: the tool bit is configured to loosen the fastener from the fastened material based on the tool bit being rotated in the second tool rotation direction;
Feature 6: a driving mechanism (or two or more gears) configured to transmit a rotational force of the motor to the output shaft to thereby rotate the output shaft in the first tool rotation direction or the second tool rotation direction;
Feature 7: a drive circuit configured to supply an electric power to the motor to thereby rotate the motor;
Feature 8: a rotation controller (or a rotation control circuit) configured to rotate the motor via the drive circuit so that the output shaft is rotated in the second tool rotation direction;
Feature 9: a calculator (or a calculation circuit) configured to increase a determination value in accordance with a lapse of time from a first timing;
Feature 11: the calculator is configured to vary (or change) a rate of increase in the determination value in accordance with a speed parameter (or rotation speed information);
Feature 12: the first timing reaches after the rotation controller starts rotating the motor so that the output shaft rotates in the second tool rotation direction;
Feature 13: the speed parameter relates to a rotation speed of the motor; and
Feature 14: a deceleration controller (or a deceleration control circuit) configured to decelerate or stop the motor via the drive circuit based on the determination value having reached (or reaching) a threshold value.

Decelerating the motor corresponds to decreasing a rotation speed of the motor. The deceleration controller may, for example, control the drive circuit so that the rotation speed of the motor decreases. Stopping the motor corresponds to stopping the rotation of the motor. The deceleration controller may, for example, control the drive circuit so that the rotation of the motor is stopped.

The electric power tool including at least features 1 through 14 can decelerate or stop the motor in a state where the fastener is properly loosened.

The first timing may arrive based on a loosening start requirement being satisfied. The loosening start requirement is required in order to rotate the output shaft in the second tool rotation direction.

The rate of increase corresponds to an increase in the determination value per unit time (or a specified period of time) or at each specified increase timing. The determination value may be cumulatively increased from an initial value. The initial value may be determined in any manner. The initial value may be, for example, zero.

The tool bit may be detachably attached to the output shaft. The tool bit may be fixed to the output shaft in a non-detachable manner.

The speed parameter may be a value that defines the rotation speed of the motor. For example, the electric power tool may be configured so that a target rotation speed of the motor is calculated. In this case, the speed parameter may be the target rotation speed. For example, the electric power tool may be configured to control the drive circuit so that the motor rotates at a command rotation speed. The command rotation speed may be gradually increased toward the target rotation speed. In this case, the speed parameter may be the command rotation speed. The speed parameter may be an actual rotation speed of the motor.

The threshold value may be determined in any manner. The threshold value may be determined in advance. The threshold value may be determined in advance in accordance with the type, material, and the like of the fastener and/or the fastened material. The determination value when the fastened material is sufficiently loosened may be experimentally obtained. The determination value obtained experimentally may be set as the threshold value. A user of the electric power tool may be able to change the threshold value.

The fastener may be in any form. The fastener may be provided with a screw thread, for example. Specifically, the fastener may be in the form of various types of screws, bolts, and nuts, for example. The various types of screws may include wood screws and drill screws, for example.

One embodiment may include, in addition to or in place of at least any one of the aforementioned features 1 through 14,
Feature 15: the calculator is configured to decrease the rate of increase as the speed parameter decreases.

The electric power tool including at least features 1 through 15 can decelerate or stop the motor at an appropriate timing in accordance with the rotation speed of the motor (that is, timing at which the fastener is properly loosened).

One embodiment may include, in addition to or in place of at least any one of aforementioned features 1 through 15, at least any one of:
Feature 16: the calculator includes a count variable determiner (or a count variable determination circuit or count value determiner) configured to determine a count variable (or a count value) at each second timing (or integration timing) based on the speed parameter at the second timing, the count variable being equivalent (or corresponding) to the rate of increase;
Feature 17: the second timing repeatedly arrives in accordance with the lapse of time; and
Feature 18: the calculator includes an integrator (or an integration circuit or an accumulating circuit or cumulatively adding circuit) configured to integrate (or accumulate or add cumulatively) the count variable determined by the count variable determiner to thereby calculate (or obtain) the determination value at each of the second timings.

The count variable may be any specific value (or magnitude). In the feature 18, a value obtained by integrating the count variable corresponds to the determination value. In other words, the determination value is calculated by sequentially adding the count variable to the initial value of the determination value. The determination value may be also referred to as an integrated value.

The electric power tool including at least features 1 through 14 and 16 through 18 can properly and easily determine the timing to start decelerating or stopping the motor (in other words, timing at which the fastener is determined to have been properly loosened).

One embodiment includes, in addition to or in place of at least any one of the aforementioned feature 1 through 18,
Feature 19: the count variable determiner is configured to decrease the count variable as the speed parameter decreases.

The electric power tool including at least features 1 through 14 and 16 through 19 can properly and easily determine the timing to decelerate or stop the motor in accordance with the rotation speed of the motor.

One embodiment may include, in addition to or in place of at least any one of the aforementioned features 1 through 19, at least one of:
Feature 20: a speed setter (or a speed setting circuit) configured to set a command rotation speed (or a specified rotation speed);
Feature 21: the rotation controller is configured to rotate the motor at the command rotation speed set by the speed setter; and
Feature 22: the speed parameter includes the command rotation speed.

The electric power tool including at least features 1 through 14, 16 through 18, and 20 through 22 can properly and easily determine the timing to decelerate or stop the motor in accordance with the rotation speed of the motor.

The calculator may decrease the rate of increase as the command rotation speed decreases.

One embodiment may include, in addition to or in place of at least any one of the aforementioned features 1 through 22, at least one of:
Feature 23: a hammering mechanism configured to (i) transmit the rotational force of the motor to the output shaft, (ii) receive a first torque from the output shaft, and (iii) apply a hammering force in the rotation direction to the output shaft based on receipt of the first torque, the first torque having a specified magnitude or more in a direction opposite to a rotation direction of the output shaft;
Feature 24: an impact detector (or an impact detection circuit) configured to detect the hammering; and
Feature 25: the deceleration controller is configured to decelerate or stop the motor via the drive circuit based on (i) the electric power tool being in non-hammering state and (ii) the determination value having reached (or reaching) the threshold value. The non-hammering state corresponding to a state in which the hammering is not detected by the impact detector.

The electric power tool including at least features 1 through 14 and 23 through 25 can more properly determine the timing to decelerate or stop the motor.

The deceleration controller may determine the non-hammering state in any manner. The deceleration controller may, for example, determine a state where the hammering is not detected by the impact detector as the non-hammering state. For example, the deceleration controller may determine a state where hammering has not been detected by the impact detector continuously for a specified period of time as the non-hammering state.

One embodiment may include, in addition to or in place of at least any one of the aforementioned features 1 through 25, at least one of:
Feature 26: a time counter (or time counting circuit, or timekeeper) configured to measure an elapsed time from a third timing;
Feature 27: the third timing arrives after the rotation controller starts rotating the motor so that the output shaft rotates in the second tool rotation direction;
Feature 28: a threshold time calculator (or a threshold time calculation circuit) configured to calculate a threshold time;
Feature 29: the threshold time calculator is configured to decrease the threshold time as the speed parameter increases; and
Feature 30: the deceleration controller is configured to decelerate or stop the motor via the drive circuit based on (i) the elapsed time having reached (or reaching) the threshold time and (ii) the determination value having reached (or reaching) the threshold value.

The electric power tool including at least features 1 through 14, 16 through 18, and 26 through 30 can also more properly determine the timing to decelerate or stop the motor.

The third timing may coincide with the first timing, or may be later or earlier than the first timing.

One embodiment may include, in addition to or in place of at least any one of the aforementioned features 1 through 30,
Feature 31: the deceleration controller is configured to decelerate or stop the motor via the drive circuit based on (i) the hammering not being detected by the impact detector (that is, the electric power tool being in the non-hammering state), (ii) the elapsed time having reached (or reaching) the threshold time, and (iii) the determination value having reached (or reaching) the threshold value.

The electric power tool including at least features 1 through 14, 16 through 18, 23, 24, 26 through 29, and 31 can also more properly determine the timing to decelerate or stop the motor.

One embodiment may include, in addition to or in place of at least any one of the aforementioned features 1 through 31,
Feature 32: the count variable determiner is configured to increase the count variable as the threshold time decreases.

The electric power tool including at least features 1 through 14, 16 through 18, 26 through 30, and 32 and the electric power tool including at least features 1 through 14, 16 through 18, 26 through 29, 31, and 32 can also property and easily determine the count variable.

One embodiment may include, in addition to or in place of at least any one of the aforementioned features 1 through 32,
Feature 33: the count variable contains a component inversely proportional to the threshold time.

The electric power tool including at least features 1 through 14, 16 through 18, 26 through 30, 32, and 33 and the electric power tool including at least features 1 through 14, 16 through 18, 26 through 29, and 31 through 33 can more easily determine the count variable.

One embodiment may include, in addition to or in place of at least any one of the aforementioned features 1 through 33, one or both of:
Feature 34: a first switch configured to be manually moved (or manually operated, or manipulated) by a user of the electric power tool; and
Feature 35: the rotation controller is configured to start rotating the motor so that the output shaft rotates in the second tool rotation direction based on the first switch being moved.

The loosening start requirement may be satisfied by the first switch being moved.

One embodiment may include, in addition to or in place of at least any one of the aforementioned features 1 through 35,
Feature 36: the speed setter is configured to set the command rotation speed in accordance with a moved length (or moved distance or moved amount) of the first switch.

One embodiment may include, in addition to or in place of at least any one of the aforementioned features 1 through 36, at least one of:
Feature 37: a second switch configured to be manually moved by a user of the electric power tool in order to alternatively select one operation mode from two or more operation modes;
Feature 38: a mode setter (or a mode setting circuit) configured to set the electric power tool to the one operation mode selected by the second switch;
Feature 39: the two or more operation modes are each associated with the command rotation speeds different from each other; and
Feature 40: the speed setter is configured to set the command rotation speed associated with the operation mode set by the mode setter.

In the electric power tool including at least features 1 through 14, 16 through 18, 20 through 22, and 37 through 40, the user can rotate the motor at the rotation speed desired, in addition to obtaining the aforementioned effects.

One embodiment may provide an electric power tool including at least any one of:
Feature 41: a motor configured to (i) rotate in a first direction to thereby tighten a fastener to a fastened material, or (ii) rotate in a second direction to thereby loosen the fastener from the fastened material;
Feature 42: a rotation direction setter (or a rotation direction setting circuit) configured to set a rotation direction of the motor to the first direction or the second direction;
Feature 43: a control circuit configured to control a rotation speed of the motor;
Feature 44: the control circuit is configured to rotate the motor in the second direction based on the rotation direction of the motor being set to the second direction;
Feature 45: the control circuit is configured to increase a specified determination value in accordance with a lapse of time from a first timing, the first timing arriving after the control circuit starts rotating the motor in the second direction;
Feature 46: the control circuit is configured to decelerate or stop the motor based on the determination value having reached (or reaching) a threshold value; and
Feature 47: the control circuit is configured to vary (or change) a rate of increase in the determination value in accordance with a speed parameter of the motor.

The electric power tool including at least features 41 through 47 can decelerate or stop the motor in a state where the fastener is properly loosened.

One embodiment may include, in addition to or in place of at least any one of the aforementioned features 41 through 47, one or both of:
Feature 48: increasing the determination value includes integrating a count variable at a specific timing, and a value obtained by integrating the count variable corresponds to the determination value; and
Feature 49: varying (or changing) the rate of increase includes varying (or changing) the count variable.

The specific timing may repeatedly arrive periodically or a periodically. The control circuit may vary the count variable in accordance with the speed parameter of the motor.

In one embodiment, the control circuit may be integrated into a single electronic unit, a single electronic device, or a single circuit board.

In one embodiment, the control circuit may be a combination of two or more electronic circuits, or a combination of two or more electronic units, or a combination of two or more electronic devices, each of which is individually disposed in the electric power tool.

In one embodiment, the control circuit may include a microcomputer (or a microcontroller, or a microprocessor), a wired logic, an application-specific integrated circuit (ASIC), an application-specific standard product (ASSP), a programmable logic device (such as a field programmable gate array (FPGA)), a discrete electronic component, and/or a combination of the above.

One embodiment may provide a method for controlling a motor in an electric power tool, the method including at least any one of:
Feature 50: rotating a tool bit in a specified rotation direction by a motor, the tool bit being configured to (i) be attached to the electric power tool and (ii) loosen a fastener from a fastened material based on the tool bit being rotated in the specified rotation direction;
Feature 51: increasing a determination value in accordance with a lapse of time from a first timing;
Feature 52: varying (or changing) a rate of increase in the determination value in accordance with a speed parameter, the speed parameter being related to a rotation speed of the motor; and
Feature 53: decelerating or stopping the motor based on the determination value having reached (or reaching) a threshold value.

The method including at least features 50 through 53 can stop the motor in a state where the fastener is properly loosened.

Examples of the electric power tool include any types of job-site electric apparatus that are used at job sites, for example, of do-it-yourself carpentry, manufacturing, gardening, and construction. The examples of the electric power tool may be configured to be driven by a battery, or may be configured to be driven by receiving an alternating-current power.

Specifically, the examples of the electric power tool may include an electric power tool for masonry work, metalworking, or woodworking, a work machine for gardening, or a device for preparing an environment of a job site, and more specifically, an electric driver or an electric wrench, for example.

In one embodiment, the aforementioned features 1 through 53 may be combined in any manner.

In one embodiment, any of the aforementioned features 1 through 53 may be excluded.

### 2. Specific Example Embodiments

Some specific example embodiments will be described below. These specific example embodiments are merely one example. The present disclosure is not limited to these embodiments, and may be practiced in any form.

### 2-1. First Embodiment

2-1-1. Configuration of Electric Power Tool

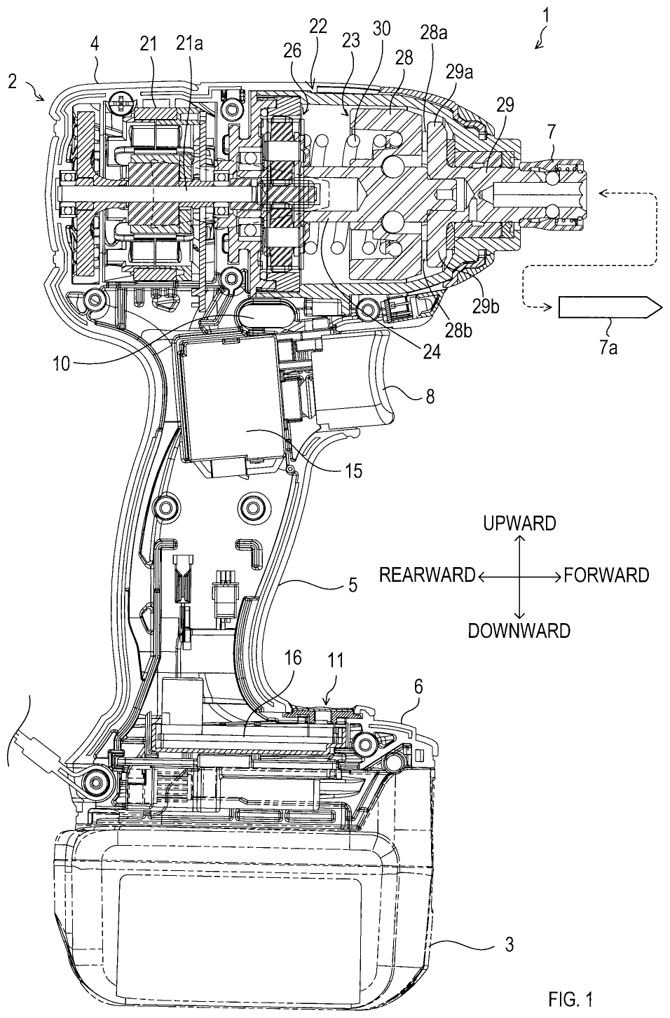

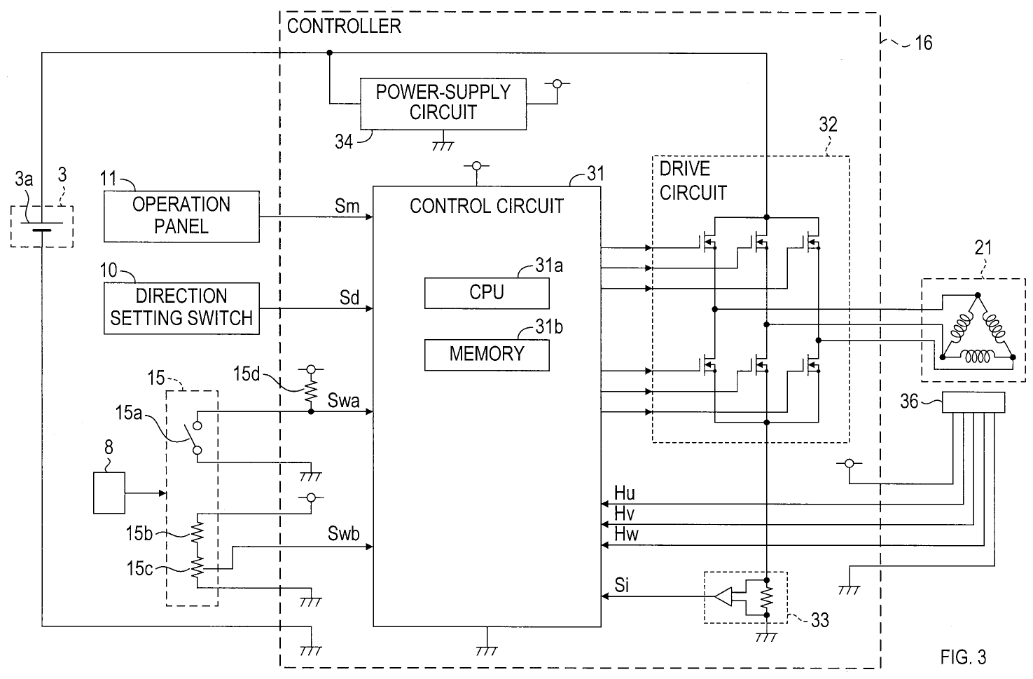

An electric power tool 1 of the first embodiment shown in FIG. 1 is in the form of, for example, an impact driver. The impact driver rotates a fastener. The fastener has a screw thread. The fastener may be in the form of, for example, various types of screws, bolts, or nuts. Various types of screws may include, for example, wood screws and drill screws. The impact driver can apply a hammering force to the fastener in a rotation direction of the fastener while rotating the fastener. The electric power tool 1 of the first embodiment is driven by electric power of a later-described battery 3a (see FIG. 3).

The electric power tool 1 includes a main body 2. The electric power tool 1 includes a battery pack 3. The battery pack 3 of the first embodiment is detachably attached to the main body 2. The battery pack 3 supplies the electric power to the main body 2.

The main body 2 includes a housing 4. The main body 2 includes a grip 5. The grip 5 is provided at a lower end of the housing 4. In the first embodiment, the grip 5 extends downward from the housing 4. The grip 5 is gripped by a user of the electric power tool 1.

The main body 2 includes a battery port 6. The battery port 6 is provided at a lower end of the grip 5. The battery pack 3 is detachably attached to the battery port 6.

The main body 2 includes a chuck sleeve (or a tool attachment portion) 7. The chuck sleeve 7 is provided at a front end of the housing 4. A tool bit is detachably attached to the chuck sleeve 7. The tool bit may be in the form of, for example, a driver bit or a socket bit. FIG. 1 schematically shows a driver bit 7a. When the chuck sleeve 7 rotates, the tool bit rotates with the chuck sleeve 7 (that is, integrally rotates). The chuck sleeve 7 is rotated by a later-described motor 21.

The main body 2 includes a trigger 8. The trigger 8 is provided in an upper front of the grip 5. The trigger 8 is manually moved (or manipulated) by the user. More specifically, in the first embodiment, the trigger 8 is pulled by the user. In other words, the trigger 8 is moved rearward to be thereby pushed into the main body 2. The electric power tool 1 operates by the trigger 8 being pulled.

The main body 2 includes a direction setting switch 10. The direction setting switch 10 specifies a rotation direction of the motor 21 (and a rotation direction of the chuck sleeve 7). Specifically, the direction setting switch 10 alternatively specifics the rotation direction of the chuck sleeve 7 to a first tool rotation direction or a second tool rotation direction.

The direction setting switch 10 is provided near the boundary between the housing 4 and the grip 5. The direction setting switch 10 of the first embodiment is manually moved (or manipulated) by the user to the right or left direction. Specifically, the direction setting switch 10 is moved to a first position (for example, a right end) or a second position (for example, a left end).

When the direction setting switch 10 is moved to the first position, the rotation direction of the chuck sleeve 7 is set to the first tool rotation direction. In other words, the rotation direction of the motor 21 is set to the first direction. The motor 21 rotates in the first direction when (i) the direction setting switch 10 is moved to the first position and (ii) the trigger 8 is pulled. When the motor 21 rotates in the first direction, the chuck sleeve 7 rotates in the first tool rotation direction. The first tool rotation direction may coincide with the first direction, or may be opposite to the first direction. In the first embodiment, the first tool rotation direction coincides with the first direction. The first tool rotation direction may be, for example, a clockwise direction (or a right-handed direction).

The first tool rotation direction corresponds to a direction to tighten the fastener to a fastened material. Specifically, the tool bit rotating in the first tool rotation direction rotates the fastener in the first tool rotation direction. When the fastener rotates in the first tool rotation direction, the fastener is tightened to the fastened material.

The fastened material may be in any form (or any member). The fastened material may be in the form of, for example, wood, metal, concrete, or gypsum board. A bolt and a nut are sometimes used in combination as the fastener and the fastened material, respectively.

When the direction setting switch 10 is moved to the second position, the rotation direction of the chuck sleeve 7 is set to the second tool rotation direction. In other words, the rotation direction of the motor 21 is set to the second direction. When (i) the direction setting switch 10 is moved to the second position and (ii) the trigger 8 is pulled, the motor 21 is rotated in the second direction. When the motor 21 rotates in the second direction, the chuck sleeve 7 rotates in the second tool rotation direction. The second tool rotation direction may coincide with the second direction, or may be opposite to the second direction. In the first embodiment, the second tool rotation direction coincides with the second direction. The second tool rotation direction may be for example, a counterclockwise direction (or a left-handed direction).

The second tool rotation direction corresponds to a direction to loosen (or release or remove) the fastener from the fastened material. Specifically, the tool bit rotating in the second tool rotation direction rotates the fastener in the second tool rotation direction. When the fastener rotates in the second tool rotation direction, the fastener is loosened from the fastened material.

In the following description, rotation of the chuck sleeve 7 in the second tool rotation direction and rotation of the motor 21 in the second direction are referred to as “reverse rotation”. Reverse rotation of the motor 21 corresponds to rotation of the motor 21 in the second direction. Reverse rotation of the chuck sleeve 7 or the tool bit 7a corresponds to rotation of the chuck sleeve 7 or the tool bit 7a in the second tool rotation direction.

The direction setting switch 10 may be movable also to a third position. The third position may be, for example, midway between the first position and the second position. When the direction setting switch 10 is moved to the third position, rotation of the motor 21 may be prohibited. For example, when the direction setting switch 10 is in the third position, the motor 21 is configured not to rotate even if the trigger 8 is pulled. For example, when the direction setting switch 10 is in the third position, movement of the trigger 8 itself may be mechanically restricted.

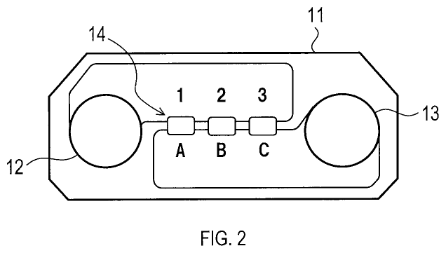

The main body 2 includes an operation panel 11. In the first embodiment, the operation panel 11 is provided on the battery port 6. The operation panel 11 includes, for example, one or more buttons and/or one or more display devices. As illustrated in FIG. 2, in the first embodiment, the operation panel 11 includes a first setting switch 12, a second setting switch 13, and an indicator 14.

The first setting switch 12 and the second setting switch 13 are manipulated (for example, depressed) by the user. The operation mode of the electric power tool 1 is switched in response to the first setting switch 12 or the second setting switch 13 being manipulated.

Specifically, the operation mode is alternatively set to one of two or more speed modes in response to the first setting switch 12 being manipulated. In the first embodiment, the two or more speed modes include, for example, a low speed mode, a medium speed mode and a high speed mode. Each of the two or more speed modes defines a maximum rotation speed of the motor 21. In other words, each of the two or more speed modes defines a maximum number of hammerings per unit time (one minute, for example). The maximum rotation speed (or the maximum number of hammerings) in the low speed mode is the lowest, and the maximum rotation speed in the high speed mode is the highest. The numerals “1”, “2” and “3” shown in FIG. 2 respectively indicate the low speed mode, the medium speed mode and the high speed mode.

The operation mode is alternatively set to one of two or more work modes in response to the second setting switch 13 being manipulated. In the first embodiment, the two or more work modes include, for example, a Wood mode and a Bolt mode. Each of the two or more work modes defines a maximum rotation speed of the motor 21 and/or an operation after hammering starts. In the Wood mode, the maximum rotation speed and/or the operation after hammering starts are set so that tightening or loosening operation of the fastener on or from wood can be performed properly. In the Bolt mode, the maximum rotation speed, the operation after hammering starts and/or an operation after hammering ends are set so that (i) tightening or loosening operation of a bolt or nut and/or (ii) tightening and loosening operation of the fastener on or from a metal fastened material can be performed properly. In the Bolt mode, at least part of the settings during forward rotation of the motor 21 may differ from the settings during the reverse rotation of the motor 21. For example, in the Bolt mode, the operation after hammering starts may be set during the forward rotation, and the operation after hammering ends may be set during the reverse rotation. Each of the texts “A”, “B” and “C” in FIG. 2 indicates one of the two or more work modes.

The indicator 14 displays information indicating the current operation mode. The indicator 14 of the first embodiment includes two or more LEDs. Each of the two or more LEDs is turned ON or OFF in accordance with the current operation mode. The indicator 14 may be in the form different from the two or more LEDs.

The electric power tool 1 includes the motor 21. The motor 21 is housed in the housing 4. The motor 21 includes a shaft 21a. Rotation of the motor 21 specifically corresponds to rotation of the shaft 21a.

The electric power tool 1 includes a driving mechanism 22. The driving mechanism 22 is housed in the housing 4. The driving mechanism 22 is disposed in front of the motor 21 and behind the chuck sleeve 7. The driving mechanism 22 transmits the rotation of the motor 21 (that is, the rotation of the shaft 21a) to the chuck sleeve 7. When the motor 21 rotates, the chuck sleeve 7 rotates.

The driving mechanism 22 includes a hammering mechanism 23. The hammering mechanism 23 includes a spindle 24. The spindle 24 is rotatably supported in the hammering mechanism 23. The driving mechanism 22 includes a planetary gear mechanism 26. The shaft 21a is coupled to the planetary gear mechanism 26. The planetary gear mechanism 26 transmits the rotation of the motor 21 to the spindle 24. When the motor 21 rotates, the spindle 24 rotates.

The hammering mechanism 23 includes a hammer 28, an anvil 29, and a coil spring 30. The hammer 28 is coupled to the spindle 24. The hammer 28 is rotatable integrally with the spindle 24. The hammer 28 is also movable along a rotation axis of the spindle 24 (that is, in a front-rear direction). The hammer 28 is biased forward by the coil spring 30. The anvil 29 receives a rotational force and/or a hammering force from the hammer 28 to thereby rotate. The chuck sleeve 7 is attached to a front end of the anvil 29.

In the first embodiment, a rotation axis of the motor 21, the rotation axis of the spindle 24, a rotation axis of the hammer 28, a rotation axis of the anvil 29 and a rotation axis of the chuck sleeve 7 coincide with each other.

The hammer 28 includes, for example, a first protrusion 28a and a second protrusion 28b. The first protrusion 28a and the second protrusion 28b apply the rotational force and/or the hammering force to the anvil 29 (in detail, to a first arm 29a and a second arm 29b to be described later). In the first embodiment, the first protrusion 28a and the second protrusion 28b are separated from each other by 180° along a rotation direction of the hammer 28. The first protrusion 28a and the second protrusion 28b protrude forward from a front end surface of the hammer 28.

The first arm 29a and the second arm 29b are provided at a rear end of the anvil 29. In the first embodiment, the first arm 29a and the second arm 29b are separated from each other by 180° along the rotation direction of the hammer 28.

In a state where the hammer 28 is biased forward by the coil spring 30, the first protrusion 28a and the second protrusion 28b can respectively contact the first arm 29a and the second arm 29b in the rotation direction of the hammer 28. The first protrusion 28a includes a first contact surface configured to contact the first arm 29a or the second arm 29b. The second protrusion 28b includes a second contact surface configured to contact the first arm 29a or the second arm 29b. The first contact surface and the second contact surface may be, for example, perpendicular to or substantially perpendicular to the rotation direction of the hammer 28. The first arm 29a includes a first contacted surface configured to be brought into contact with the first protrusion 28a or the second protrusion 28b. The second arm 29b includes a second contacted surface configured to be brought into contact with the first protrusion 28a or the second protrusion 28b. The first contacted surface and the second contacted surface may be, for example, perpendicular to or substantially perpendicular to a rotation direction of the anvil 29.

When the spindle 24 is rotated by the motor 21, the hammer 28 rotates integrally with the spindle 24. When the hammer 28 rotates in a state where the first protrusion 28a and the second protrusion 28b respectively contact the first arm 29a and the second arm 29b, the rotational force of the hammer 28 is transmitted from the first protrusion 28a and the second protrusion 28b to the anvil 29 via the first arm 29a and the second arm 29b. This rotates the anvil 29. When the anvil 29 rotates, the chuck sleeve 7 rotates integrally with the anvil 29. This causes a tool bit attached to the chuck sleeve 7 to rotate.

During the rotation of the motor 21, the hammer 28 receives a load torque (or a load torque is applied to the hammer 28) from the fastener via the chuck sleeve 7 and the anvil 29. The load torque corresponds to a torque in a direction opposite to the rotation direction of the hammer 28. The hammer 28, when receiving a first torque during the rotation of the hammer 28, is displaced rearward against a biasing force of the coil spring 30 while applying the rotational force to the anvil 29. The first torque corresponds to the load torque having a specified magnitude or more. Specifically, the first protrusion 28a and the second protrusion 28b are displaced rearward while maintaining the contacts with the first arm 29a and the second arm 29b. As the rearward displacement of the hammer 28 proceeds, the first protrusion 28a and the second protrusion 28b respectively climb over the first arm 29a and the second arm 29b in the rotation direction of the hammer 28. In other words, the first protrusion 28a and the second protrusion 28b respectively move away from the first arm 29a and the second arm 29b in the rotation direction of the hammer 28. This causes the hammer 28 to spin, and displaces the hammer 28 forward by the biasing force of the coil spring 30. As a result, the first protrusion 28a and the second protrusion 28b respectively collide with the first arm 29a and the second arm 29b. In other words, the first protrusion 28a and the second protrusion 28b respectively hit the first arm 29a and the second arm 29b in the rotation direction of the hammer 28.

Such hitting (that is, hammering) is repeatedly performed while the hammer 28 is receiving the first torque. In other words, while the hammer 28 is receiving the first torque, the anvil 29 receives intermittent hammerings from the hammer 28.

When hammering occurs while the motor 21 rotates in the first direction, the fastener is tightened to the fastened material with high torque. When hammering occurs while the motor 21 rotates reversely, the fastener tightened to the fastened material is loosened with high torque.

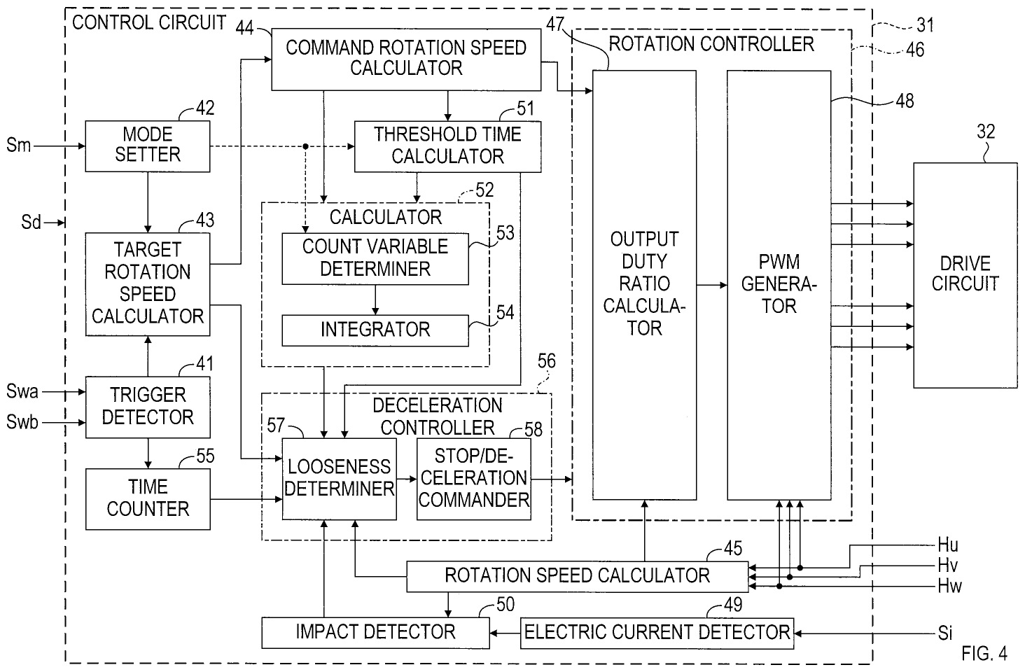

The main body 2 includes a controller 16. The controller 16 controls various functions of the electric power tool 1, including driving of the motor 21. Detailed configuration of the controller 16 will be described by way of FIGS. 3 and 4.

The main body 2 includes a switch box 15. The switch box 15 is coupled to the trigger 8. As will be described later, the switch box 15 outputs various signals to the controller 16 in accordance with the state (specifically, the moved length) of the trigger 8.

2-1-2. Electrical Configuration of Electric Power Tool

Referring to FIG. 3, a supplementary description of the electrical configuration of the electric power tool 1 will be given. FIG. 3 shows a state where the battery pack 3 is attached to the main body 2.

The battery pack 3 includes a battery 3a. The battery 3a may be, for example, configured to be repeatedly chargeable. The battery 3a may be, for example, a lithium ion rechargeable battery. The battery 3a may be a rechargeable battery different from a lithium ion rechargeable battery.

The electric power tool 1 includes the motor 21, the controller 16, the switch box 15, the direction setting switch 10 and the operation panel 11.

When the battery pack 3 is attached to the main body 2, the controller 16 is electrically coupled to the battery 3a. This supplies the electric power of the battery 3a (hereinafter, referred to as the “battery power”) to the controller 16.

In the first embodiment, the motor 21 is, for example, in the form of a brushless DC motor. The motor 21 includes a permanent magnet rotor (not shown). The above-described shaft 21a is fixed to the rotor and rotates integrally with the rotor.

The motor 21 is driven by the battery power. The motor 21 receives the battery power via a drive circuit 32. The drive circuit 32 converts the battery power to a three-phase power. In detail, the motor 21 is driven by the three-phase power. The motor 21 of the first embodiment includes three windings. The three-phase power is supplied to the three windings. FIG. 3 shows the three windings delta-connected to each other. The three windings may be coupled to each other in a manner different from delta connection.

The electric power tool 1 includes a rotation sensor 36. The rotation sensor 36 outputs rotational position information. The rotational position information may indicate whether the motor 21 is rotating. The rotational position information may change in accordance with the rotational position and/or the actual rotation speed of the motor 21. The rotational position information may indicate the rotational position of the motor 21 (specifically, rotational position of the rotor 19). The rotational position information of the present embodiment includes a first position signal Hu, a second position signal Hv and a third position signal Hw. The rotational position information is input to the control circuit 31.

The rotation sensor 36 of the first embodiment includes three Hall sensors (not shown). The three Hall sensors are arranged near the rotor of the motor 21. More specifically, the three Hall sensors are arranged so as to be separated from each other by an angle corresponding to the electrical angle of 120 degrees along a rotation direction of the shaft 21a. The first to third position signals Hu, Hv, Hw are output from the three respective Hall sensors.

The rotation sensor 36 of the first embodiment operates by the electric power from the controller 16. Specifically, the rotation sensor 36 receives a power-supply voltage Vcc from the controller 16. The rotation sensor 36 is coupled to a control power-supply line and a ground line, which will be described later, inside the controller 16.

The switch box 15 includes a trigger switch 15a, a resistor 15b, and a variable resistor 15e. The trigger switch 15a and the variable resistor 15c operate in conjunction with the movement of the trigger 8.

When the trigger 8 is pulled, the trigger switch 15a is turned ON. When the trigger 8 is not pulled, the trigger switch 15a is turned OFF. The trigger switch 15a is provided to detect whether the trigger 8 is pulled. A first end and a second end of the trigger switch 15a are coupled to the controller 16.

The resistor 15b and the variable resistor 15c are coupled to each other in series. A first end of the resistor 15b is coupled to the controller 16, and a second end of the resistor 15b is coupled to a first end of the variable resistor 15c. A second end and a moving contact of the variable resistor 15c is coupled to the controller 16. The moving contact slides along a resistive element of the variable resistor 15c. The position of the moving contact changes in accordance with the moved length (or moved distance or moved amount or pulled amount or position) of the trigger 8. The variable resistor 15c is provided to detect the moved length of the trigger 8.

The controller 16 includes the control circuit 31 and the drive circuit 32. The control circuit 31 controls the rotation of the motor 21.

The drive circuit 32 receives the battery power from the battery 3a. The drive circuit 32 is coupled to a positive electrode of the battery 3a. The controller 16 is provided with the ground line coupled to a negative electrode of the battery 3a. The drive circuit 32 is also coupled to the ground line.

The drive circuit 32 is coupled to the motor 21. The drive circuit 32 supplies the three-phase power to the motor 21. The drive circuit 32 of the first embodiment is in the form of a three-phase full-bridge circuit. The three-phase full-bridge circuit includes six switches. The six switches may be in any form. In the first embodiment, the six switches are, for example, each in the form of n-channel metal oxide semiconductor field-effect transistor (MOSFET).

The controller 16 includes an electric current detection circuit 33. The electric current detection circuit 33 detects a motor current value. The motor current value corresponds to a value (or the magnitude) of a motor current. The motor current corresponds to the electric current supplied from the battery 3a to the motor 21. The electric current detection circuit 33 is provided on an electric power path. The electric power path extends from the positive electrode of the battery 3a to the negative electrode of the battery 3a via the drive circuit 32 and the motor 21. In the first embodiment, the electric current detection circuit 33 is more specifically disposed on the negative side path. The negative side path corresponds to a path of the electric power path between the drive circuit 32 and the ground line. The electric current detection circuit 33 of the first embodiment includes a resistor on the negative side path. The electric current detection circuit 33 outputs an electric current detection signal Si in accordance with the magnitude of voltage between both ends of the resistor (that is, in accordance with the magnitude of the electric current flowing in the negative side path). The electric current detection signal Si is input to the control circuit 31.

The controller 16 includes a power-supply circuit 34. The power-supply circuit 34 receives the battery power from the battery 3a. The power-supply circuit 34 (i) generates a power-supply power from the battery power, and (ii) outputs the power-supply power to the control power-supply line. The power-supply power has the above-described power-supply voltage Vcc. The power-supply voltage Vcc, for example, has a fixed voltage value. The power-supply power is supplied to each part of the controller 16, including the control circuit 31, via the control power-supply line. The control circuit 31 operates by the power-supply power.

The power-supply power is also supplied to the switch box 15. Specifically, the power-supply voltage Vcc is applied to the first end of the trigger switch 15a via a resistor 15d. The second end of the trigger switch 15a is coupled to the ground line. The power-supply voltage Vcc is also applied to the first end of the resistor 15b. The second end of the variable resistor 15c is coupled to the ground line.

The first end of the trigger switch 15a is coupled to the control circuit 31. The voltage at the first end of the trigger switch 15a is input to the control circuit 31 as a first trigger signal Swa. The first trigger signal Swa indicates whether the trigger switch 15a is turned ON, in other words, whether the trigger 8 is pulled.

The moving contact of the variable resistor 15c is coupled to the control circuit 31. The voltage of the moving contact is input to the control circuit 31 as a second trigger signal Swb. The second trigger signal Swb indicates the moved length of the trigger 8.

The control circuit 31 of the first embodiment is provided with a microcomputer including a CPU 31a, a memory 31b, and so on. The memory 31b may include, for example, a semiconductor memory such as a ROM, a RAM, a NVRAM, and a flash memory.

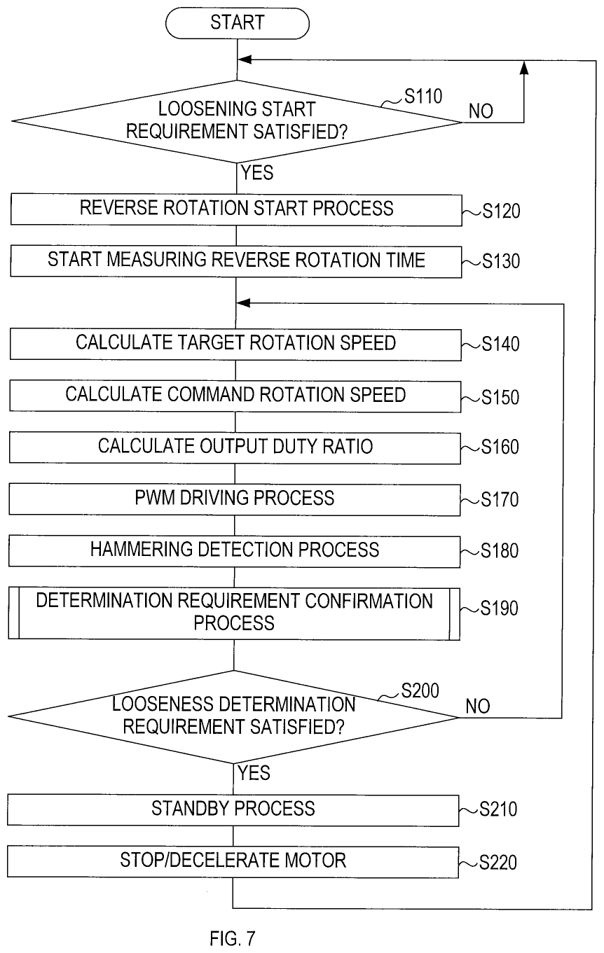

The control circuit 31 implements various functions by executing a program stored in a non-transitory tangible storage medium (that is, in accordance with the program or software). In the present embodiment, the memory 31b corresponds to the non-transitory tangible storage medium that stores the program. In the present embodiment, the memory 31b stores a program for a later-described reverse rotation control process (see FIG. 7).

In other embodiments, the control circuit 31 may be provided with a wired logic (or a hard wired circuit), an ASIC, an ASSP, a programmable logic device (for example, FPGA), a discrete electronic component, and/or a combination thereof, instead of or in addition to the microcomputer.

The control circuit 31 receives the rotational position information (that is, the first to third position signals Hu, Hv, Hw), the electric current detection signal Si, the first trigger signal Swa and the second trigger signal Swb. The control circuit 31 also receives a direction setting signal Sd from the direction setting switch 10. The direction setting signal Sd indicates the position of the direction setting switch 10. The control circuit 31 also receives a mode setting signal Sm from the operation panel 11. The mode setting signal Sm indicates the user's manipulation on the first setting switch 12 and the second setting switch 13. When the first setting switch 12 is manipulated, the operation panel 11 outputs the mode setting signal Sm that indicates that the first setting switch 12 has been manipulated. When the second setting switch 13 is manipulated, the operation panel 11 outputs the mode setting signal Sm that indicates that the second setting switch 13 has been manipulated.

The control circuit 31 detects the rotational position of the motor 21 (that is, rotational position of the rotor) and the actual rotation speed based on the rotational position information. The control circuit 31 detects the motor current value based on the electric current detection signal Si. The control circuit 31 detects whether the trigger 8 has been moved based on the first trigger signal Swa. The control circuit 31 detects the moved length of the trigger 8 based on the second trigger signal. Swb.

The control circuit 31 detects which of the first direction and the second direction is specified based on the direction setting signal Sd. The control circuit 31 sets the rotation direction of the motor 21 to the specified direction.

The control circuit 31 detects that the first setting switch 12 or the second setting switch 13 has been manipulated based on the mode setting signal Sm. The control circuit 31 switches the operation mode of the electric power tool 1 each time the manipulation on the first setting switch 12 or the second setting switch 13 is detected. Specifically, each time the first setting switch 12 is manipulated, the control circuit 31 sequentially switches the operation mode to one of the aforementioned two or more speed modes. Also, each time the second setting switch 13 is manipulated, the control circuit 31 sequentially switches the operation mode to one of the aforementioned two or more work modes.

The control circuit 31 outputs a drive command to the drive circuit 32. The drive circuit 32 supplies the three-phase power to the motor 21 based on the drive command. The drive command includes six drive signals for six respective switches in the drive circuit 32. The control circuit 31 sets, for example, one of the six switches to an ON hold switch and sets another switch to a PWM switch by the drive command. For example, if one of the high-side switches is set to the ON hold switch, one of the low-side switches is set to the PWM switch. “PWM” is an abbreviation for “pulse-width modulation”. The high-side switches correspond to three switches of the six switches between the positive electrode of the battery 3a and the motor 21. The low-side switches correspond to three switches of the six switches between the negative electrode of the battery 3a and the motor 21. For example, if one of the low-side switches is set to the ON hold switch, one of the high-side switches is set to the PWM switch. The PWM switch and the ON hold switch are not coupled to each other in series.

The ON hold switch is held in an ON-state. The control circuit 31 outputs a drive signal for holding the ON-state to the ON hold switch. On the other hand, the PWM switch is driven based on a pulse-width modulation signal (PWM signal). In other words, the drive signal output to the PWM switch is in the form of a PWM signal. The PWM signal has a duty ratio (hereinafter, referred to as “output duty ratio”). The PWM switch is periodically turned ON or OFF in accordance with the PWM signal. The output duty ratio is determined in accordance with a later-described command rotation speed.

2-1-3. Motor Control

The control circuit 31, when the trigger 8 is pulled, rotates the motor 21 to the set rotation direction. In the first embodiment, the control circuit 31 performs, for example, a speed feedback control.

Specifically, the control circuit 31 determines a target (or desired) rotation speed in accordance with the second trigger signal Swb. The control circuit 31 calculates the command rotation speed in accordance with the target rotation speed. The target rotation speed indicates a rotation speed of the motor 21 to be finally reached. The command rotation speed indicates a rotation speed actually commanded to the motor 21 via the drive circuit 32.

The command rotation speed may be the same as the target rotation speed or may differ from the target rotation speed. The command rotation speed may be set to a rotation speed that is the same as or lower than the target rotation speed, for example, (i) in accordance with a drive state of the motor 21, (ii) in accordance with the operation mode, or (iii) in accordance with the pulled amount of the trigger 8. The electric power tool 1 of the first embodiment has a so-called soft start function. When the motor 21 is started, the command rotation speed is not immediately set to the target rotation speed that corresponds to a moved length of the trigger 8. When the motor 21 is started, the command rotation speed gradually increases toward the target rotation speed in accordance with a lapse of time.

The control circuit 31 controls the drive circuit 32 (and thus controls the three-phase power) so that the motor 21 rotates at the command rotation speed. Specifically, the control circuit 31 compares the detected actual rotation speed (hereinafter, referred to as “detected rotation speed”) with the command rotation speed. The control circuit 31 controls the drive circuit 32 so that the actual rotation speed coincides with the command rotation speed. For example, the control circuit 31 calculates the output duty ratio so that the lower the detected rotation speed than the command rotation speed, the greater the output duty ratio.

The control circuit 31 calculates the output duty ratio for each control timing. In the first embodiment, the control timing arrives repeatedly (that is, periodically) at a specific control cycle. The control circuit 31 (i) calculates the output duty ratio and (ii) drives the PWM switch based on the output duty ratio, for each control timing.

The control circuit 31, while rotating the motor 21 reversely, determines whether a looseness determination requirement is satisfied. The looseness determination requirement is required to determine that the fastener is loosened from the fastened material. When the looseness determination requirement is satisfied, the control circuit 31 decelerates or stops the motor 21.

The control of the motor 21 mentioned as above will be specifically explained with reference to FIG. 4. In the first embodiment, the control of the motor 21 by the control circuit 31 is implemented by the CPU 31a executing a computer program (that is, by software processing). The computer program includes a program of a motor control process. The motor control process controls the rotation of the motor 21. The program of the motor control process includes a program of the reverse rotation control process in FIG. 7. The reverse rotation control process controls the reverse rotation of the motor 21. The control circuit 31 (specifically, the CPU 31a) functions as shown in FIG. 4 by executing the program of the motor control process.

As shown in FIG. 4, the control circuit 31 includes a trigger detector 41. The trigger detector 41 receives the first trigger signal Swa and the second trigger signal Swb from the switch box 15. The trigger detector 41 (i) detects whether the trigger 8 is pulled based on the first trigger signal Swa, and (ii) outputs trigger detection information indicating a result of detection. The trigger detector 41 detects the moved length of the trigger 8 based on the second trigger signal Swb.

The control circuit 31 includes a mode setter 42. The mode setter 42 receives the mode setting signal Sm from the operation panel 11. The mode setter 42 sets the operation mode of the electric power tool 1 to one of the aforementioned two or more speed modes and two or more work modes based on the mode setting signal Sm.

The control circuit 31 includes a target rotation speed calculator 43. The target rotation speed calculator 43 calculates the target rotation speed. The target rotation speed calculator 43 acquires the trigger detection information and the moved length of the trigger 8 from the trigger detector 41. The target rotation speed calculator 43 acquires the set operation mode from the mode setter 42. The target rotation speed calculator 43, for example, calculates the target rotation speed in accordance with the set operation mode and the moved length of the trigger 8 while the trigger 8 is pulled. The target rotation speed may be calculated, for example, so that the target rotation speed increases in accordance with the increase in the moved length of the trigger 8. The maximum value of the target rotation speed may differ depending on the operation mode.

The control circuit 31 includes a command rotation speed calculator 44. The command rotation speed calculator 44 acquires the calculated target rotation speed from the target rotation speed calculator 43. The command rotation speed calculator 44 calculates the command rotation speed based on the acquired target rotation speed.

The control circuit 31 includes a rotation speed calculator 45. The rotation speed calculator 45 receives the rotational position information from the rotation sensor 36. The rotation speed calculator 45 detects (that is, calculates) the actual rotation speed of the motor 21 based on the rotational position information.

The control circuit 31 includes a rotation controller 46. The rotation controller 46 generates the drive command, and outputs the drive command to the drive circuit 32. The rotation controller 46 includes an output duty ratio calculator 47 and a PWM generator 48.

The output duty ratio calculator 47 acquires the command rotation speed currently calculated from the command rotation speed calculator 44. The output duty ratio calculator 47 also acquires the detected rotation speed currently calculated from the rotation speed calculator 45. The output duty ratio calculator 47 uses the aforementioned speed feedback control to calculate the output duty ratio based on the acquired command rotation speed and detected rotation speed.

The PWM generator 48 acquires the output duty ratio calculated in the output duty ratio calculator 47. The PWM generator 48 also acquires the rotational position information. The PWM generator 48 also receives the direction setting signal Sd from the direction setting switch 10. The PWM generator 48 generates the drive command based on the output duty ratio, the rotational position information and the direction setting signal Sd, and outputs the drive command to the drive circuit 32. Specifically, the PWM generator 48 detects the rotational position of the motor 21 based on the rotational position information. The PWM generator 48 generates the drive command based on the detected rotational position so that the motor 21 rotates in a rotation direction indicated by the direction setting signal Sd. The drive command generated at this time can include, for example, a drive signal to the ON hold switch and a drive signal to the PWM switch. The drive signal to the PWM switch has the output duty ratio calculated in the output duty ratio calculator 47.

The control circuit 31 includes an electric current detector 49. The electric current detector 49 receives the electric current detection signal Si. The electric current detector 49 detects the motor current value based on the electric current detection signal Si.

The control circuit 31 includes a hammering detector 50. The hammering detector 50 detects whether hammering has been made in the hammering mechanism 23. The hammering detector 50 acquires the motor current value from the electric current detector 49. The hammering detector 50 acquires the detected rotation speed from the rotation speed calculator 45.

The hammering detector 50 may detect hammering in any manner. The hammering detector 50 may detect hammering, for example, based on the detected rotation speed. As described above, hammering occurs intermittently while the hammer 28 receives the first torque. Therefore, while hammering occurs intermittently, the detected rotation speed fluctuates in accordance with the interval between occurrences of hammering. Specifically, while hammering occurs intermittently, the detected rotation speed alternately takes a local maximum and a local minimum. While hammering occurs intermittently, the detected rotation speed takes the local maximum immediately before hammering occurs (that is, immediately before the hammer 28 hits the anvil 29). On the other hand, when the hammer 28 climbs over the anvil 29, the detected rotation speed takes the local minimum. The hammering detector 50 detects the local maximum and the local minimum of the detected rotation speed. The hammering detector 50, each time the local maximum or the local minimum is detected, calculates an extreme value difference. The extreme value difference is an absolute value of an amount of change in extreme value. The amount of change in extreme value is a difference between the detected local maximum or local minimum and the last detected local maximum or local minimum. The extreme value difference calculated when the local maximum is detected is an absolute value of a difference between the local maximum and the last detected local minimum. The extreme value difference calculated when the local minimum is detected is an absolute value of a difference between the local minimum and the last detected local maximum. The hammering detector 50 may determine (that is, detect) that hammering has been made when the extreme value difference is greater than or equal to a specified threshold. The hammering detector 50 may determine that hammering has been made when (i) the extreme value difference is greater than or equal to the specified threshold and (ii) time elapsed since the extreme value is last detected is within a specified period of time. The hammering detector 50 may determine that the electric power tool 1 is in non-hammering state when the extreme value difference greater than or equal to the specified threshold has not been detected for the specified period of time or longer. The non-hammering state corresponds to a state where no hammering is made.

The hammering detector 50 may detect hammering based on the motor current value. While hammering occurs, the motor current value also fluctuates in the same manner as the rotation speed, and can take a local maximum and a local minimum. Therefore, the hammering detector 50 may detect the hammering based on the motor current value, in the same manner as the aforementioned manner that is based on the detected rotation speed.

The control circuit 31 includes a threshold time calculator 51. The threshold time calculator 51 calculates threshold time when the motor 21 rotates reversely. The threshold time is one of determination criteria for determining that the fastener is loosened.

As will be described later, in order to determine that the fastener is loosened, it is required that reverse rotation time (or elapsed time) reaches the threshold time. The reverse rotation time is a time period during which the motor 21 continues to rotate reversely. The starting point of the reverse rotation time may be determined in any manner. The starting point of the reverse rotation time may be, for example, when a loosening start requirement is satisfied (or a loosening start condition (in other words, drive condition for reverse rotation) is established). The starting point of the reverse rotation time may be, for example, when the drive command for reverse rotation is output to the drive circuit 32. The starting point of the reverse rotation time may be when starting of the reverse rotation of the motor 21 is actually detected by the rotational position information. In the first embodiment, for example, measurement of the reverse rotation time is started in response to the loosening start requirement being satisfied. The loosening start requirement may be satisfied, for example, in response to (i) the direction setting signal Sd indicating the reverse rotation and (ii) pulling of the trigger 8 being detected based on the first trigger signal Swa.

The threshold time calculator 51 calculates the threshold time based on the calculated command rotation speed. Specifically, in the first embodiment, the threshold time is set so that the higher the command rotation speed, the shorter the threshold time. The threshold time may change continuously or change stepwisely in accordance with the command rotation speed.

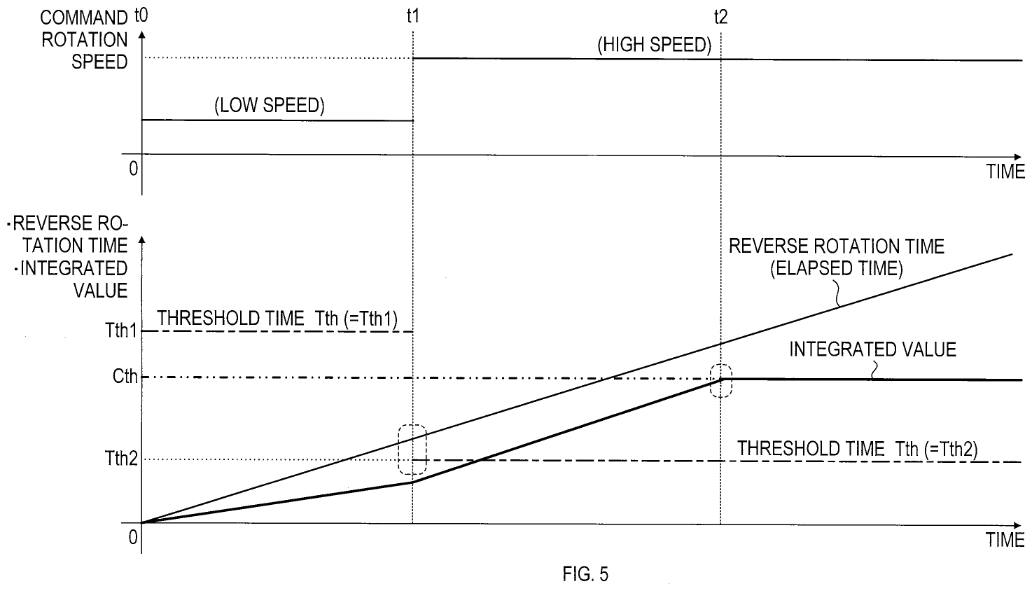

FIG. 5 shows an example of the threshold time. In FIG. 5, the trigger 8 is pulled at time t0, and further pulled at time t1. Therefore, the command rotation speed increases at time t1. At time t0 to t1, the command rotation speed is low, and a threshold time Tth is set to a first threshold time Tth1. At time t1 and later, the command rotation speed is high, and the threshold time Tth is set to a second threshold time Tth2. The second threshold time Tth2 is shorter than the first threshold time Tth1.

In the first embodiment, the command rotation speed calculator 44 repeatedly (that is, periodically) calculates the command rotation speed. Each time the command rotation speed is calculated, the threshold time calculator 51 calculates the threshold time based on the calculated command rotation speed.

The control circuit 31 includes a calculator 52. The calculator 52 calculates an integrated value. The integrated value is one of the determination criteria for determining that the fastener is loosened. While the motor 21 rotates reversely, the calculator 52 repeatedly (that is, periodically) calculates the integrated value. In the first embodiment, the calculator 52 repeatedly calculates the integrated value at the control cycle during the reverse rotation. The control cycle during the reverse rotation corresponds to a cycle at which the command rotation speed is calculated during the reverse rotation. In other words, each time the command rotation speed is calculated, the integrated value is calculated based on the command rotation speed calculated. Alternatively, each time the command rotation speed is calculated, the integrated value may be calculated based on the threshold time that is calculated based on the command rotation speed calculated. The control cycle during the reverse rotation corresponds to a cycle at which the processes of S140 to S190 are repeated in the later-described reverse rotation control process in FIG. 7.

The integrated value is calculated by a count variable (or a count value or a counted value or a counted variable or an incremented value) being integrated (or cumulatively added) for each calculation timing of the integrated value (that is, repeatedly at the above-described control cycle).

The calculator 52 includes a count variable determiner 53 and an integrator 54. The count variable determiner 53 determines the above-described count variable. The integrator 54 integrates (that is, cumulatively adds) the count variable determined in the count variable determiner 53.

The count variable determiner 53 calculates the count variable based on the rotation speed of the motor 21. The count variable reflects the rotation speed of the motor 21. The count variable may reflect the rotation speed of the motor 21 in any manner. In the first embodiment, each time the command rotation speed is calculated in the command rotation speed calculator 44, the count variable is determined (that is, calculated) based on the calculated command rotation speed. Specifically, the count variable determiner 53 reduces the count variable as the command rotation speed decreases. The count variable determiner 53 may vary (or change) the count variable continuously or stepwisely in accordance with the varying in the command rotation speed.

The threshold time calculator 51 calculates the threshold time based on the command rotation speed. The count variable determiner 53 may determine the count variable based on the threshold time. Specifically, the count variable determiner 53 may reduce the count variable as the threshold time becomes longer (in other words, as the command rotation speed decreases). More specifically, the count variable may be determined so as to be inversely proportional to the threshold time. Alternatively, the count variable may be determined so that the count variable contains a component inversely proportional to the threshold time.

The integrator 54, each time the count variable is determined in the count variable determiner 53 (that is, each time the command rotation speed is calculated, in other words, repeatedly at the aforementioned control cycle), integrates the determined count variable to thereby calculate the integrated value.

Therefore, the integrated value increases in accordance with a lapse of time. However, a rate of increase in the integrated value varies in accordance with the count variable. Specifically, the smaller the count variable, the smaller the rate of increase in the integrated value. Conversely, the greater the count variable, the greater the rate of increase in the integrated value. As described above, the count variable is calculated based on the command rotation speed or the threshold time. Therefore, the higher the command rotation speed, the greater the rate of increase in the integrated value. Conversely, the lower the command rotation speed, the smaller the rate of increase in the integrated value.

The control circuit 31 includes a time counter 55. The time counter 55 measures the reverse rotation time. The time counter 55 starts measuring the reverse rotation time when the loosening start requirement is satisfied. More specifically, the time counter 55 starts measuring the reverse rotation time when the direction setting signal Sd indicates the reverse rotation and pulling of the trigger 8 is detected in the trigger detector 41.

The control circuit 31 includes a deceleration controller 56. The deceleration controller 56 includes a looseness determiner 57 and a stop/deceleration commander 58. The looseness determiner 57 determines whether the looseness determination requirement is satisfied during the reverse rotation of the motor 21. The looseness determination requirement is required to determine that the fastener is in a state of being loosened from the fastened material (hereinafter, referred to as “loosened state”).

In the first embodiment, the looseness determiner 57 determines whether the first to third requirements below are satisfied. The looseness determiner 57 determines that the looseness determination requirement is satisfied (that is, the fastener is in loosened state) if (i) the first requirement and the second requirement are satisfied, or (ii) the first requirement and the third requirement are satisfied.
(1) First requirement: the electric power tool 1 is in non-hammering state where no hammering is made.
(2) Second requirement: the reverse rotation time has reached the threshold time and the integrated value has reached an integration threshold.
(3) Third requirement: the detected rotation speed is greater than or equal to a speed threshold.

Specifically, the first requirement is satisfied if no hammering is detected by the hammering detector 50 for a specified period of time or longer. The non-hammering state corresponds to a state where hammering is not detected for the specified period of time or longer. A period of time from when the motor 21 starts driving until hammering is firstly detected is also included in the non-hammering state, and satisfies the first requirement.

The second requirement is satisfied specifically based on (1) the measured reverse rotation time having reached (or reaching) the calculated threshold time and (ii) the calculated integrated value having reached (or reaching) the integration threshold. The integration threshold may be determined in any manner. The integration threshold may be set to a constant value in advance.

The third requirement is satisfied specifically in response to the calculated detected rotation speed being greater than or equal to the speed threshold.

The looseness determiner 57 outputs a looseness notification when the looseness determination requirement is satisfied. The looseness notification indicates that the looseness determination requirement is satisfied, that is, the fastener is in loosened state.

The control circuit 31 includes the stop/deceleration commander 58. The stop/deceleration commander 58, when receiving the looseness notification from the looseness determiner 57, outputs a stop/deceleration command to the rotation controller 46. The stop/deceleration command commands the rotation controller 46 to decelerate or stop the motor 21.

The rotation controller 46, when receiving the stop/deceleration command while the motor 21 rotates reversely, decelerates or stops the motor 21. Specifically, for example, the output duty ratio calculator 47 reduces the output duty ratio or sets the output duty ratio to zero. In this case, the output duty ratio calculator 47 may determine an amount to reduce from the output duty ratio based on the current output duty ratio. Alternatively, the output duty ratio calculator 47 may vary the output duty ratio to a preset value regardless of the current output duty ratio. Alternatively, for example, the PWM generator 48 may output the drive command for stopping the motor 21 to the drive circuit 32.

2-1-4. Operation Example During Reverse Rotation

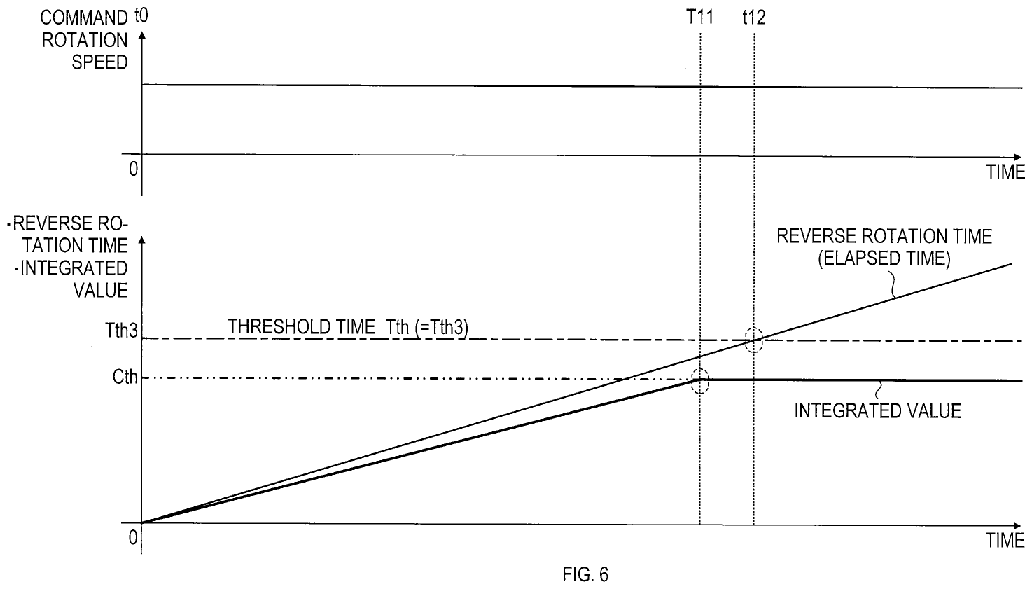

Referring to FIGS. 5 and 6, an operation example of the electric power tool 1 when the motor 21 rotates reversely and the fastener is loosened from the fastened material will be described. In FIGS. 5 and 6, the third requirement is not included in the looseness determination requirement to simplify the explanation. In FIGS. 5 and 6, if the first requirement and the second requirement are satisfied, the looseness determination requirement is satisfied.

In FIG. 5, as described above, the reverse rotation is started at time t0 and the pulled amount of the trigger 8 increases at time t1. As a result, the command rotation speed increases. The motor 21 rotates at low speed until time t1. Therefore, the fastener is loosened comparatively slowly until time t1. The fastener is not yet sufficiently loose at time t1. In addition, since the command rotation speed is low until time t1, the first threshold time Tth1 is calculated. Therefore, the reverse rotation time does not reach the first threshold time Tth1 by time t1.

As the command rotation speed increases at time t1, the threshold time Tth is changed to the second threshold time Tth2. This causes the reverse rotation time to exceed the second threshold time Tth2. In other words, only a part of the second requirement is satisfied.

The motor 21 rotates at low speed until time t1. The fastener is not yet sufficiently loose at time t1. Thus, if the motor 21 is stopped at time t1, user operation to further loosen the fastener may become necessary.

However, in the first embodiment, the second requirement is not satisfied only by the reverse rotation time having reached (or reaching) the threshold time Tth. In order for the second requirement to be satisfied, the integrated value also has to reach the integration threshold. In FIG. 5, since the command rotation speed is calculated to be low until time t1, the count variable is determined to be a small value. As a result, the integrated value increases in accordance with a low rate of increase till time t1. The integrated value does not yet reach an integration threshold Cth at time t1. In other words, the second requirement is not yet satisfied at time t1.

The integrated value reaches the integration threshold Cth at time t2 when the reverse rotation of the motor 21 further progresses from time t1. In other words, the second requirement is satisfied at time t2. If the first requirement is also satisfied at time t2, the looseness determination requirement is satisfied and the motor 21 is decelerated or stopped.

Until time t2, hammering may be made or may not be made.

FIG. 6 shows an operation example during the reverse rotation when the command rotation speed is fixed, that is, the moved length of the trigger 8 remains constant. In FIG. 6, since the command rotation speed is fixed, the count variable is fixed. The integrated value also increases at a fixed rate of increase. The integrated value reaches the integration threshold Cth at time t11. In other words, at time t11, a part of the second requirement is satisfied. However, at time t11, since the reverse rotation time does not yet reach the threshold time Tth, the second requirement is not yet completely satisfied. The reverse rotation time reaches the threshold time Tth at time t12. Thus, at time t12, the second requirement is satisfied. If the first requirement is also satisfied at time t12, it is determined that the fastener is loosened, and the motor 21 is decelerated or stopped.

2-1-5. Reverse Rotation Control Process

Referring to FIG. 7, the reverse rotation control process executed by the control circuit 31 (the CPU 31a in detail) will be explained. The reverse rotation control process is a process of rotating the motor 21 reversely. When the control circuit 31 is started, the control circuit 31 executes the reverse rotation control process. The control circuit 31 executes a forward rotation control process in parallel with the reverse rotation control process. The forward rotation control process is a process of rotating the motor 21 in the first direction. The reverse rotation control process may be included in the forward rotation control process. The reverse rotation control process may be implemented anywhere and in any form in the whole motor control process.

The control circuit 31, when starting the reverse rotation control process, determines whether the loosening start requirement is satisfied in S110. When the loosening start requirement is not satisfied, the control circuit 31 repeats the determination of S110. When the loosening start requirement is satisfied, the control circuit 31 executes a reverse rotation start process (or a drive start process) in S120. The reverse rotation start process includes acquiring information required to rotate the motor 21 reversely. Specifically, in S120, the control circuit 31 acquires the moved length of the trigger 8 based on the second trigger signal Swb. This process corresponds to the processing of the trigger detector 41. In S120, the control circuit 31 also sets the operation mode based on the mode setting signal Sm. This process corresponds to the processing of the mode setter 42.

In S130, the control circuit 31 starts measuring the reverse rotation time. This process corresponds to the processing of the time counter 55.

In S140, the control circuit 31 calculates the target rotation speed based on the moved length of the trigger 8 acquired in S120 or based on the moved length and the operation mode. This process corresponds to the processing of the target rotation speed calculator 43.

In S150, the control circuit 31 calculates the command rotation speed based on the target rotation speed calculated in S140. This process corresponds to the processing of the command rotation speed calculator 44.

In S160, the control circuit 31 calculates the output duty ratio based on the command rotation speed calculated in S150 and the detected rotation speed calculated in the rotation speed calculator 45. This process corresponds to the processing of the output duty ratio calculator 47.

In S170, the control circuit 31 executes a PWM driving process. Specifically, the control circuit 31 detects the rotational position of the motor 21 based on the rotational position information. The control circuit 31 also generates the drive command based on the detected rotational position, the output duty ratio calculated in S160, and the rotation direction indicated by the direction setting signal Sd. The control circuit 31 outputs the generated drive command to the drive circuit 32. This rotates the motor 21 reversely. This process of S170 corresponds to the processing of the PWM generator 48.

In S180, the control circuit 31 executes a hammering detection process. Specifically, the control circuit 31 determines in the above-described manner whether hammering has been made based on the detected rotation speed calculated by the rotation speed calculator 45 or the motor current value detected by the electric current detector 49. This process corresponds to the processing of the hammering detector 50.

In S190, the control circuit 31 executes a determination requirement confirmation process. Specifically, the control circuit 31 determines whether each of the above-described first to third requirements is satisfied. Detail of this determination requirement confirmation process will be described later.

In S200, the control circuit 31 determines whether the looseness determination requirement is satisfied based on a result of the process of S190. The control circuit 31 determines that the looseness determination requirement is satisfied if (i) the first requirement and the second requirement are satisfied or (ii) the first requirement and the third requirement are satisfied. This process corresponds to the processing of the looseness determiner 57.

In S200, when the looseness determination requirement is not satisfied, the present process moves to S140. In this case, the reverse rotation of the motor 21 is continued. In S200, when the looseness determination requirement is satisfied, the present process moves to S210.

In S210, the control circuit 31 executes a standby process. Specifically, the control circuit 31 waits for a specified waiting time before moving to the next process of S220. In other words, the control circuit 31 continues to rotate the motor 21 reversely for the specified period of time. This process corresponds to the processing of the stop/deceleration commander 58. The reason for waiting for the specified waiting time in S210 is to loosen the fastener more so as to reduce the user's further loosening operation (for example, operation to completely remove the fastener from the fastened material) after the motor stops.

After waiting for the specified waiting time in S210, the control circuit 31 stops or decelerates the motor 21 in S220. This process corresponds to the processing of the stop/deceleration commander 58 and the rotation controller 46.

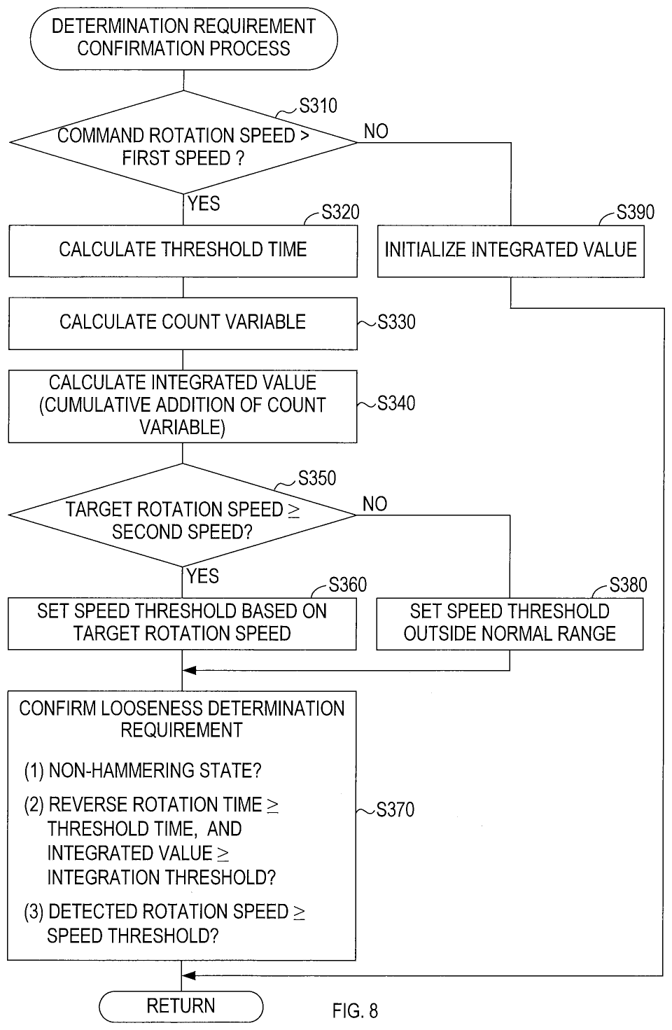

The detail of the determination requirement confirmation process in S190 will be explained with reference to FIG. 8. The control circuit 31, when starting the determination requirement confirmation process, determines in S310 whether the calculated command rotation speed is greater than a first speed. The first speed may be any speed. The first speed may be set in advance. The first speed may be, for example, zero or may be greater than zero. In the first embodiment, the first speed is zero, for example. In other words, in the first embodiment, the process of S310 corresponds to a process of determining whether the motor 21 is rotating.

In S310, when the command rotation speed is smaller or equal to the first speed, the present process proceeds to S390. In S390, the control circuit 31 initializes (that is, sets to an initial value) the integrated value. The initial value may be determined in any manner. In the first embodiment, the initial value is zero, for example. The process of S390 corresponds to the processing of the calculator 52. After S390, the present process moves to S200 (see FIG. 7).

In S310, when the command rotation speed is greater than the first speed, the present process proceeds to S320. In S320, the control circuit 31 calculates the threshold time based on the command rotation speed. This process corresponds to the processing of the threshold time calculator 51 in FIG. 4.

In S330, the control circuit 31 calculates the count variable based on the command rotation speed or the threshold time. This process corresponds to the processing of the count variable determiner 53.

In S340, the control circuit 31 calculates the integrated value. Specifically, the control circuit 31 adds the count variable calculated in S330 to the current integrated value so as to update the integrated value. Each time the process of S340 is executed, the count variable is cumulatively added and the integrated value is thus updated. The process of S340 corresponds to the processing of the integrator 54.

In S350, the control circuit 31 determines whether the calculated target rotation speed is greater than or equal to a second speed. The process of S350 is a process of determining whether the motor 21 is rotating at high speed. The second speed may be determined in any manner. The second speed may be determined to be, for example, a specified speed greater than or equal to 10,000 rpm.

In S350, when the target rotation speed is smaller than the second speed, the present process proceeds to S380. In S380, the control circuit 31 sets the speed threshold outside the normal range. The purpose of this process is to disable the third requirement, that is, to avoid establishment of the third requirement. When the rotation speed of the motor 21 is low, it is preferable that the second requirement is prioritized over the third requirement in order to properly determine whether the fastener is loosened. Therefore, when the rotation speed of the motor 21 is low, the control circuit 31 sets the speed threshold to high speed (for example, 1,000,000 rpm) so that the second requirement is satisfied and thus the looseness determination requirement is satisfied. Normally, there is no possibility or there is extremely low possibility of the actual rotation speed of the motor 21 reaching the speed threshold. After S380, the present process proceeds to S370.

In S350, when the target rotation speed is greater than or equal to the second speed, the present process proceeds to S360. In S360, the control circuit 31 sets the speed threshold based on the calculated target rotation speed.

In S370, the control circuit 31 determines whether the looseness determination requirement is satisfied. Specifically, the control circuit 31 determines whether each of the first to third requirements is satisfied. After S370, the present process moves to S200 (see FIG. 7). The processes of S350 to S380 correspond to the processing of the looseness determiner 57.

2-1-6. Correspondence of Terms

The chuck sleeve 7 corresponds to one example of the output shaft in Overview of Embodiments. The trigger 8 corresponds to one example of the first switch in Overview of Embodiments. Each of the first setting switch 12 and the second setting switch 13 corresponds to one example of the second switch in Overview of Embodiments. The control circuit 31 corresponds to one example of the deceleration controller and the speed setter in Overview of Embodiments. Specifically, the deceleration controller 56 corresponds to one example of the deceleration controller in Overview of Embodiments. The target rotation speed calculator 43 or the command rotation speed calculator 44 corresponds to one example of the speed setter in Overview of Embodiments. The reverse rotation time measured by the time counter 55 corresponds to one example of the elapsed time in Overview of Embodiments.

(i) The timing at which it is determined in S110 that the loosening start requirement is satisfied, (ii) the timing at which the process of S120 is executed, (iii) the timing at which the process of S130 is executed, or (iv) the timing at which the process of S190 or S340 is first executed after the loosening start requirement is satisfied in S110 corresponds to one example of the first timing and the third timing in Overview of Embodiments. The timing at which the process of S340 is executed corresponds to one example of the second timing in Overview of Embodiments.

The command rotation speed, the target rotation speed, or the threshold time (or a reciprocal of the threshold time) corresponds to one example of the speed parameter in Overview of Embodiments. The count variable corresponds to one example of the rate of increase in Overview of Embodiments. The integrated value corresponds to one example of the determination value in Overview of Embodiments. The integration threshold corresponds to one example of the threshold value in Overview of Embodiments.

### 2-2. Second Embodiment

An example is described in which the electric power tool 1 of the first embodiment is partially modified. In the first embodiment, the threshold time is calculated based on the command rotation speed. In addition, in the first embodiment, the count variable is calculated based on the command rotation speed or the threshold time. In the second embodiment, the threshold time is calculated in accordance with the work mode.

The time interval between hammerings (hereinafter, referred to as “hammering interval”) basically depends on the actual rotation speed of the motor 21. Specifically, in general, the higher the actual rotation speed of the motor 21, the shorter the hammering interval. However, in practice, the hammering interval does not depend only on the actual rotation speed of the motor 21, and also varies depending on other factors. Specifically, for example, the hammering interval varies also depending on the form (such as thickness, material and hardness in the fastening direction) of the fastened material.

Therefore, in the second embodiment, in order to properly determine that the fastener is loosened, the threshold time and/or the count variable are calculated in accordance with the form of the fastened material. More specifically, the threshold time and/or the count variable are calculated in accordance with the set work mode.

In the Wood mode, the target rotation speed, the command rotation speed or a drive pattern is set in assumption that the fastened material is a soft material such as wood. Specifically, for example, the target rotation speed may be set lower than that in other work modes. In the operation of loosening the fastener from the soft fastened material such as wood in the Wood mode, the actual rotation speed pulsates in long cycles due to hammering, and the period during which the hammering is made can be long.

On the other hand, in the Bolt mode, the target rotation speed, the command rotation speed or the drive pattern is set in assumption that the fastened material is a hard material such as metal. Specifically, for example, the target rotation speed may be set higher than that in the Wood mode. In addition, for example, when hammering is detected during the reverse rotation of the motor 21, the target rotation speed, the command rotation speed and/or the drive pattern may be set so that the motor 21 automatically stops when hammering is detected or after a specified period of time from when the hammering is detected. In the operation of loosening the fastener from the hard fastened material such as metal in the Bolt mode, the actual rotation speed pulsates in short cycles due to the hammering, and the period during which the hammering is made can be short.

Therefore, in the second embodiment, the threshold time calculator 51 acquires the operation mode currently set from the mode setter 42. The threshold time calculator 51, if the operation mode is set to any of the work modes, calculates the threshold time in accordance with the set work mode.

For example, when the operation mode is set to the Wood mode, the threshold time calculator 51 sets a specified first period of time to the threshold time. The first period of time corresponds to the Wood mode. On the other hand, when the operation mode is set to the Bolt mode, the threshold time calculator 51 sets a specified second period of time to the threshold time. The second period of time corresponds to the Bolt mode. The second period of time is shorter than the first period of time.

In the second embodiment, calculation of the threshold time as above is performed in S320 of FIG. 8.

Also, in the second embodiment, when the operation mode is set to any of the work modes, the target rotation speed calculator 43 sets the target rotation speed in accordance with the set work mode. The command rotation speed calculator 44 may also calculate the command rotation speed in consideration of the set work mode. In the second embodiment, calculations of the target rotation speed and the command rotation speed as above are performed in S140 and S150 of FIG. 7, respectively.

The count variable determiner 53 may acquire the currently set operation mode from the mode setter 42. When the operation mode is set to any of the work modes, the count variable determiner 53 may calculate the count variable in accordance with the set work mode.

For example, if the operation mode is set to the Wood mode, the count variable determiner 53 may set a specified first value to the count variable. The first value corresponds to the Wood mode. On the other hand, if the operation mode is set to the Bolt mode, the count variable determiner 53 may set a specified second value to the count variable. The second value corresponds to the Bolt mode. The second value may be greater than the first value.

Alternatively, the count variable determiner 53 may calculate the count variable based on the threshold time calculated by the threshold time calculator 51. For example, the count variable may be calculated so that the longer the threshold time, the smaller the count variable.

In the second embodiment, calculation of the count variable as above is performed in S330 of FIG. 8.

FIG. 4 schematically shows by broken lines that the threshold time calculator 51 and the count variable determiner 53 acquire the operation mode from the mode setter 42.

In the second embodiment, the waiting time in S210 of FIG. 7 may be changeable in accordance with the work mode. For example, when the fastener is loosened from the soft fastened material, hammering ends in early stages, and this increases the actual rotation speed. Therefore, in early stages, the looseness determination requirement is satisfied and the motor 21 can be stopped. In this case, the motor 21 can be stopped in a state where the fastener is not yet sufficiently loose. Therefore, for example, the waiting time in the Wood mode may be set longer than the waiting time in the Bolt mode.

### 2-3. Other Embodiments

The embodiments of the present disclosure have been described above. However, the present disclosure is not limited to the above-described embodiments and can be practiced with various modifications.

(1) In the above-described embodiments, the count variable is calculated based on the command rotation speed or the threshold time. However, the count variable may be calculated based on one or more parameters that reflect the actual rotation speed of the motor 21 (or parameters that are related to the actual rotation speed).

For example, the count variable may be calculated based on the target rotation speed. In that case, the count variable determiner 53 may determine the count variable so that the lower the target rotation speed, the smaller the count variable.

Also, for example, the count variable determiner 53 may determine the count variable based on the actual rotation speed of the motor 21. Specifically, the count variable determiner 53 may determine the count variable based on the detected rotation speed calculated at each timing to determine the count variable. In this case, the count variable determiner 53 may determine the count variable so that the lower the detected rotation speed, the smaller the count variable.

(2) The threshold time may be calculated in any manner. The threshold time may be, for example, calculated based on the target rotation speed. Specifically, the threshold time may be calculated so that the higher the target rotation speed, the shorter the threshold time. Alternatively, the threshold time may be fixed (or constant).

(3) The target rotation speed and/or the command rotation speed may be a fixed speed regardless of the moved length of the trigger 8. The fixed speed may be separately determined for each operation mode.

(4) The waiting time in S210 of FIG. 7 can be changed in accordance with a specified condition or as required. For example, the waiting time may be set by the user's input. The following effect can be obtained by the waiting time being changeable.

Specifically, the length of the fastener is not necessarily constant and is varied. Thus, if the waiting time is fixed, the motor 21 may be stopped in a state where the fastener is excessively loose or is not sufficiently loose. Specifically, for example, when the length of the fastener is long, the motor 21 may be stopped before the fastener is loosened to the position desired by the user.

In addition, as described above, the timing to determine the looseness can also differ depending on firmness of the fastened material. Thus, for example, when the fastener is loosened from the soft fastened material, the motor 21 may be stopped before the fastener is loosened to the position desired by the user.

In contrast, the changeable waiting time makes it possible to stop the motor 21 at the position desired by the user regardless of the length of the fastener or firmness of the fastened material. For example, in case of performing an operation of loosening a long bolt, setting longer waiting time can delay the timing to stop the motor 21 and loosen the fastener to a desired position. Conversely, in case of performing an operation of loosening a short bolt, setting shorter waiting time can advance the timing to stop the motor 21 and avoid excessive loosening. In addition, for example, in case of performing an operation of loosening the fastener from the soft fastened material, setting longer waiting time can delay the timing to stop the motor 21 and loosen the fastener to a desired position.

(5) In the above-described embodiments, the trigger 8 is shown as one example of the first switch of the present disclosure. However, the first switch may be in the form different from the trigger 8. The first switch may be, for example, in the form of such as a slide switch, a push button, and a lever. The specific form of the second switch of the present disclosure may be also in the form different from the first setting switch 12 and the second setting switch 13 of the above-described embodiments (that is, push buttons).

(6) The present disclosure can be applied to any electric power tools provided with a hammering function. For example, the present disclosure can be applied to an impact wrench.

In addition, the present disclosure can be also applied to an electric power tool without the hammering mechanism 23 (that is, without a hammering function). Specifically, the present disclosure can be applied to an electric power tool in any form that can rotate a fastener. Specifically, the present disclosure can be applied, for example, to an electric power tool for masonry work, metalworking, or woodworking.

The electric power tool of the present disclosure may be able to perform an operation different from rotation of a fastener, in addition to the rotation of a fastener. For example, a drill bit may be attachable to the electric power tool, and the drill bit may be able to drill a hole in a workpiece.

A function performed by a single element in the above-described embodiments may be achieved by a plurality of elements, or a function performed by a plurality of elements may be achieved by a single element. At least a part of a configuration in the above-described embodiments may be replaced by a known configuration having a similar function. A part of a configuration in the above-described embodiments may be omitted. Moreover, at least a part of a configuration in the above-described embodiments may be added to, or may replace, a configuration in other embodiment described above. Any form included in the technical idea defined by Overview of Embodiments may be an embodiment of the present disclosure.

What is claimed is:

1. An electric power tool comprising:
a motor;
an output shaft configured to (i) attach a tool bit thereto, and (ii) receive a rotational force of the motor to thereby rotate in a first tool rotation direction or a second tool rotation direction together with the tool bit, the second tool rotation direction being opposite to the first tool rotation direction, the tool bit being configured to (i) tighten a fastener to a fastened material based on the tool bit being rotated in the first tool rotation direction, and (ii) loosen the fastener from the fastened material based on the tool bit being rotated in the second tool rotation direction;
a drive circuit configured to supply an electric power to the motor to thereby rotate the motor;
a rotation controller configured to rotate the motor via the drive circuit so that the output shaft rotates in the second tool rotation direction;
a calculator configured to (i) increase a determination value in accordance with a lapse of time from a first timing, and (ii) vary a rate of increase in the determination value in accordance with a speed parameter, the first timing arriving after the rotation controller starts rotating the motor so that the output shaft rotates in the second tool rotation direction, the speed parameter being related to a rotation speed of the motor; and
a deceleration controller configured to decelerate or stop the motor via the drive circuit based on the determination value having reached a threshold value.

2. The electric power tool according to claim 1, wherein
the calculator is configured to decrease the rate of increase as the speed parameter decreases.

3. The electric power tool according to claim 1, wherein
the calculator includes:
a count variable determiner configured to determine a count variable at each second timing based on the speed parameter at the second timing, the second timing repeatedly arriving in accordance with the lapse of time, the count variable being equivalent to the rate of increase; and
an integrator configured to integrate the count variable determined by the count variable determiner to thereby calculate the determination value at each of the second timings.

4. The electric power tool according to claim 3, wherein
the count variable determiner is configured to decrease the count variable as the speed parameter decreases.

5. The electric power tool according to claim 3, further comprising:
a speed setter configured to set a command rotation speed, wherein
the rotation controller is configured to rotate the motor at the command rotation speed set by the speed setter, and
the speed parameter includes the command rotation speed.

6. The electric power tool according to claim 1, further comprising:
a hammering mechanism configured to (i) transmit the rotational force of the motor to the output shaft, (ii) receive a first torque from the output shaft, and (iii) apply a hammering force in the rotation direction to the output shaft based on receipt of the first torque, the first torque having a specified magnitude or more in a direction opposite to a rotation direction of the output shaft; and
an impact detector configured to detect the hammering,
wherein the deceleration controller is configured to decelerate or stop the motor via the drive circuit based on (i) the hammering not being detected by the impact detector and (ii) the determination value having reached the threshold value.

7. The electric power tool according to claim 3, further comprising:
a time counter configured to measure an elapsed time from a third timing, the third timing arriving after the rotation controller starts rotating the motor so that the output shaft rotates in the second tool rotation direction; and
a threshold time calculator configured to calculate a threshold time, the threshold time calculator being configured to decrease the threshold time as the speed parameter increases, wherein
the deceleration controller is configured to decelerate or stop the motor via the drive circuit based on, (i) the elapsed time having reached the threshold time and (ii) the determination value having reached the threshold value.

8. The electric power tool according to claim 3, further comprising:
a hammering mechanism configured to (i) transmit the rotational force of the motor to the output shaft, (ii) receive a first torque from the output shaft, and (iii) apply a hammering force in the rotation direction to the output shaft based on receipt of the first torque, the first torque having a specified magnitude or more in a direction opposite to a rotation direction of the output shaft;
an impact detector configured to detect the hammering;
a time counter configured to measure an elapsed time from a third timing, the third timing arriving after the rotation controller starts rotating the motor so that the output shaft rotates in the second tool rotation direction; and
a threshold time calculator configured to calculate a threshold time, the threshold time calculator being configured to decrease the threshold time as the speed parameter increases, wherein
the deceleration controller is configured to decelerate or stop the motor via the drive circuit based on (i) the hammering not being detected by the impact detector, (ii) the elapsed time having reached the threshold time, and (iii) the determination value having reached the threshold value.

9. The electric power tool according to claim 7, wherein
the count variable determiner is configured to increase the count variable as the threshold time decreases.

10. The electric power tool according to claim 9,
the count variable contains a component inversely proportional to the threshold time.

11. The electric power tool according to claim 1, further comprising:
a first switch configured to be manually moved by a user of the electric power tool, wherein
the rotation controller is configured to start rotating the motor so that the output shaft rotates in the second tool rotation direction based on the first switch being moved.

12. The electric power tool according to claim 5, further comprising:
a first switch configured to be manually moved by a user of the electric power tool, wherein
the speed setter is configured to set the command rotation speed in accordance with a moved length of the first switch.

13. The electric power tool according to claim 5, further comprising:
a second switch configured to be manually moved by a user of the electric power tool in order to alternatively select one operation mode from two or more operation modes; and
a mode setter configured to set the electric power tool to the one operation mode selected by the second switch, wherein
the two or more operation modes are each associated with the command rotation speeds different from each other, and
the speed setter is configured to set the command rotation speed associated with the operation mode set by the mode setter.

14. An electric power tool comprising:
a motor configured to (i) rotate in a first direction to thereby tighten a fastener to a fastened material or (ii) rotate in a second direction to thereby loosen the fastener from the fastened material;
a rotation direction setter configured to set a rotation direction of the motor to the first direction or the second direction; and
a control circuit configured to control a rotation speed of the motor,
the control circuit being configured to:
rotate the motor in the second direction based on the rotation direction of the motor being set to the second direction;
increase a specified determination value in accordance with a lapse of time from a first timing, the first timing arriving after the control circuit starts rotating the motor in the second direction,
decelerate or stop the motor based on the determination value having reached a threshold value, and
vary a rate of increase in the determination value in accordance with a speed parameter of the motor.

15. The electric power tool according to claim 14, wherein
increasing the determination value includes integrating a count variable at a specific timing, a value obtained by integrating the count variable corresponding to the determination value, and
varying the rate of increase includes varying the count variable.

16. A method for controlling a motor in an electric power tool, the method comprising:
rotating a tool bit in a specified rotation direction by a motor, the tool bit being configured to (i) be attached to the electric power tool and (ii) loosen a fastener from a fastened material based on the tool bit being rotated in the specified rotation direction;
increasing a determination value in accordance with a lapse of time from a first timing;
varying a rate of increase in the determination value in accordance with a speed parameter, the speed parameter being related to the rotation speed of the motor; and
decelerating or stopping the motor based on the determination value having reached a threshold value.
